(19) United States
(12) Patent Application Publication
(10) Pub. No.: US 2013/0281025 A1
(43) Pub. Date: Oct. 24, 2013

(54) FACILITATING THE INITIATION OF A WIRELESS COMMUNICATION SESSION

(71) Applicants: Jukka Reunamäki, Tampere (FI); Arto Palin, Viiala (FI); Jari Nikara, Lempaala (FI)

(72) Inventors: Jukka Reunamäki, Tampere (FI); Arto Palin, Viiala (FI); Jari Nikara, Lempaala (FI)

(73) Assignee: NOKIA CORPORATION, Espoo (FI)

(21) Appl. No.: 13/450,187

(22) Filed: Apr. 18, 2012

(51) Int. Cl. H04W 24/00; H04W 4/00

(52) U.S. Cl. 455/67.11; 455/39

(57) ABSTRACT

An apparatus comprises at least one processor, and at least one memory including computer program code, the at least one memory and the computer program code configured to, with the at least one processor, cause the apparatus to receive a signal indicative of a request to initiate a wireless communication session using an antenna of a first wireless communication device, and responsive to the signal, to cause an indicator to be displayed on a display of the first wireless communication device, the indicator being configured to indicate to a user an orientation of the first wireless communication device with respect to a second communication device for facilitating the initiation of a wireless communication session between the first wireless communication device and the second wireless communication device using the antenna.

### FIELD

This specification relates generally to facilitating the initiation of a wireless communication session between two devices

### BACKGROUND

Many types of short-range, or local, wireless communication systems are well known in the art. These include Bluetooth, Bluetooth Low Energy, near field communication (NFC), Wi-Fi and other types of wireless local area networks (WLANs).

### SUMMARY

In a first aspect, this specification describes an apparatus comprising at least one processor and at least one memory including computer program code, the at least one memory and the computer program code configured to, with the at least one processor, cause the apparatus to receive a signal indicative of a request to initiate a wireless communication session using an antenna of a first wireless communication device, and responsive to the signal, to cause an indicator to be displayed on a display of the first wireless communication device, the indicator being configured to indicate to a user an orientation of the first wireless communication device with respect to a second communication device for facilitating the initiation of a wireless communication session between the first wireless communication device and the second wireless communication device using the antenna.

The at least one memory and the computer program code may be configured, with the at least one processor, to cause the apparatus to measure a strength of a signal received at the antenna from the second wireless communication device and to cause an indication of the measured signal strength to be provided to the user of the first wireless communication device.

The at least one memory and the computer program code may be configured, with the at least one processor, to cause the apparatus to determine if a measured strength of the received signal is above a predetermined threshold, and when the measured strength of the received signal is above the predetermined threshold, to initiate a wireless communication session with the second wireless communication device. The at least one memory and the computer program code may be configured, with the at least one processor, to cause the apparatus to cause an indication of the initiation of the wireless communication session to be provided to the user of the first wireless communication device.

In a second aspect, this specification describes, a method comprising receiving a signal indicative of a request to initiate a wireless communication session using an antenna of a first wireless communication device, and responding to the signal by causing an indicator to be displayed on a display of the first wireless communication device, the indicator being configured to indicate to a user an orientation of the first wireless communication device with respect to a second communication device for facilitating the initiation of a wireless communication session between the first wireless communication device and the second wireless communication device using the antenna.

The method may further comprise measuring a strength of a signal received at the antenna from the second wireless communication device, and causing an indication of the measured signal strength to be provided to the user of the first wireless communication device.

The method may further comprise determining if a measured strength of the received signal is above a predetermined threshold, and when the measured strength of the received signal is above the predetermined threshold, initiating a wireless communication session with the second wireless communication device. The method may comprise causing an indication of the initiation of the wireless communication session to be provided to the user of the first wireless communication device.

In a third aspect, this specification describes computer-readable code which, when executed by computing apparatus, causes the computing apparatus to perform a method in accordance with the second aspect.

In a fourth aspect, the specification describes a non-transitory computer readable memory medium having computer readable instructions stored thereon, the computer readable instructions, when executed by at least one processor, causing the at least one processor to receive a signal indicative of a request to initiate a wireless communication session using an antenna of a first wireless communication device, and responsive to the signal, to cause an indicator to be displayed on a display of the first wireless communication device, the indicator being configured to indicate to a user an orientation of the first wireless communication device with respect to a second communication device for facilitating the initiation of a wireless communication session between the first wireless communication device and the second wireless communication device using the antenna.

In a fifth aspect, this specification describes apparatus comprising means for receiving a signal indicative of a request to initiate a wireless communication session using an antenna of a first wireless communication device, and means for responding to the signal by causing an indicator to be displayed on a display of the first wireless communication device, the indicator being configured to indicate to a user an orientation of the first wireless communication device with respect to a second communication device for facilitating the initiation of a wireless communication session between the first wireless communication device and the second wireless communication device using the antenna.

In a sixth aspect, this specification describes apparatus configured to cause the apparatus to receive a signal indicative of a request to initiate a wireless communication session using an antenna of a first wireless communication device, and responsive to the signal, to cause an indicator to be displayed on a display of the first wireless communication device, the indicator being configured to indicate to a user an orientation of the first wireless communication device with respect to a second communication device for facilitating the initiation of a wireless communication session between the first wireless communication device and the second wireless communication device using the antenna.

In any of the first to sixth aspects, the indicator may be configured to indicate the orientation by indicating a location on the first wireless communication device at which a strength of a field produced by the antenna is sufficiently large to allow a wireless communication session to be initiated with a second wireless communication device. The indicator may be configured to indicate to the user a location on the first wireless communication device at which the strength of the field produced by the antenna is at a maximum.

In any of the first to sixth aspects, the request to initiate the wireless communication session may comprise a user input received at a user interface of the first wireless communications device. Alternatively, he request to initiate the wireless communication session may comprise an inquiry packet received at the antenna of the first wireless communication device from the second wireless communication device.

In any of the first to sixth aspects, the indicator may be configured to indicate a location of the antenna of the first device.

### BRIEF DESCRIPTION OF THE FIGURES

For a more complete understanding of example embodiments, reference is now made to the following description taken in connection with the accompanying drawings in which:

FIG. 1 is a simplified schematic of an apparatus in accordance with example embodiments;

FIG. 2 is a plan view of a wireless communication device comprising the apparatus of claim 1;

FIG. 3 is an example of a method which may be performed by the controller of the apparatus of FIG. 1; and

FIGS. 4, 5 and 6 illustrate aspects of the method of FIG. 3.

### DETAILED DESCRIPTION OF EMBODIMENTS

In the description and drawings, like reference numerals refer to like elements throughout.

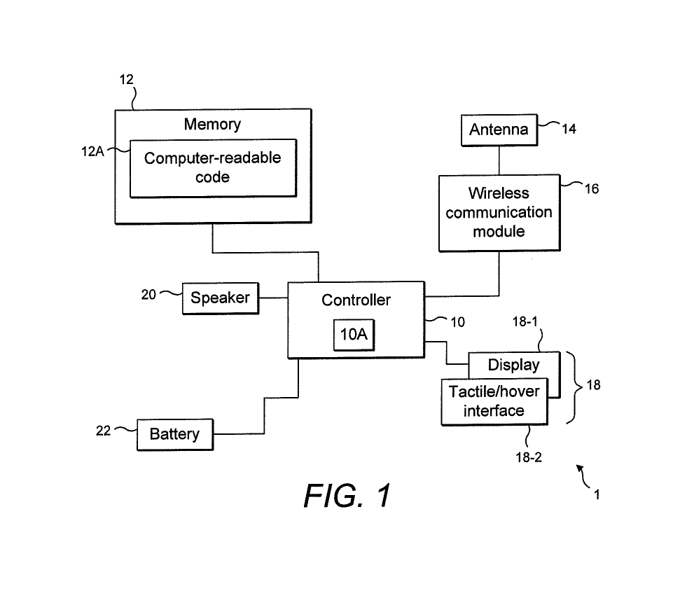

FIG. 1 is a simplified schematic of apparatus 1 in accordance with example embodiments.

The apparatus 1 comprises a controller 10 and at least one non-transitory memory medium 12. The controller 10 is operable, under the control of computer readable code 12A stored on the at least one memory medium 12, to control the various other components of the apparatus 1. The controller 10 comprises at least one processor 10A which is configured to execute the computer readable code 12A and thereby to cause actions to be performed by the other components. The controller 10 may also comprise one or more application specific integrated circuits (not shown). The at least one non-transitory memory medium 12 comprises one or more discreet memory media such as, but not limited to, ROM, RAM, flash memory and optical storage.

The apparatus 1 may be part of a wireless communication device such as a mobile telephone, a tablet computer, a laptop computer, a desktop computer, a personal digital assistant (PDA) or any other type of wireless communication device. As such, in this example, the apparatus 1 comprises an antenna 14 and a wireless communication module 16. The antenna 14 and the wireless communication module 16 are operable under the control of the controller 10 initiate and sustain a wireless communication session with another wireless communication device (not shown). The antenna 14 and the wireless communication module 16 may be configured to operate using any appropriate short range, or local, wireless communication protocol. Such protocols include, but are not limited to, Bluetooth, Bluetooth low energy, near field communication (NFC), Wi-Fi and WLAN. A wireless communication session is a session in which content is transferred over an air interface between two wireless communication devices. As such, if we consider the Bluetooth protocol, a wireless communication session may not include the inquiry process that may be used to set up the Bluetooth communication session.

The apparatus 1 may also comprise a user interface 18 including a display 18-1 and a user-input interface 18-2. The user-input interface 18-2 may be of any suitable type including, but not limited to a touch and/or hover interface and/or one or more mechanical keys. The user interface 18 is operable under the control of the controller 10. As such, the controller 10 may be configured to send signals to the display 18-1 so as to cause images to be displayed on the display 18-1. The controller 10 may also be operable to receive signals indicative of user inputs from the user input-interface 18-2 and to cause actions to occur in accordance with user inputs.

The apparatus 1 may comprise one or more other components including, but not limited to, a speaker 20 for providing audio outputs to the user and a battery 22 for providing power to the apparatus 1. It will also be appreciated that the apparatus 1 may comprise other components such as one or more additional antennas (not shown). The one or more additional antennas may be configured to communicate with other devices over a cellular communications network or another type of long-range communications network. One or more of the additional antennas may be configured for short-range or local wireless communication using, for example, NFC, Bluetooth or Wi-Fi.

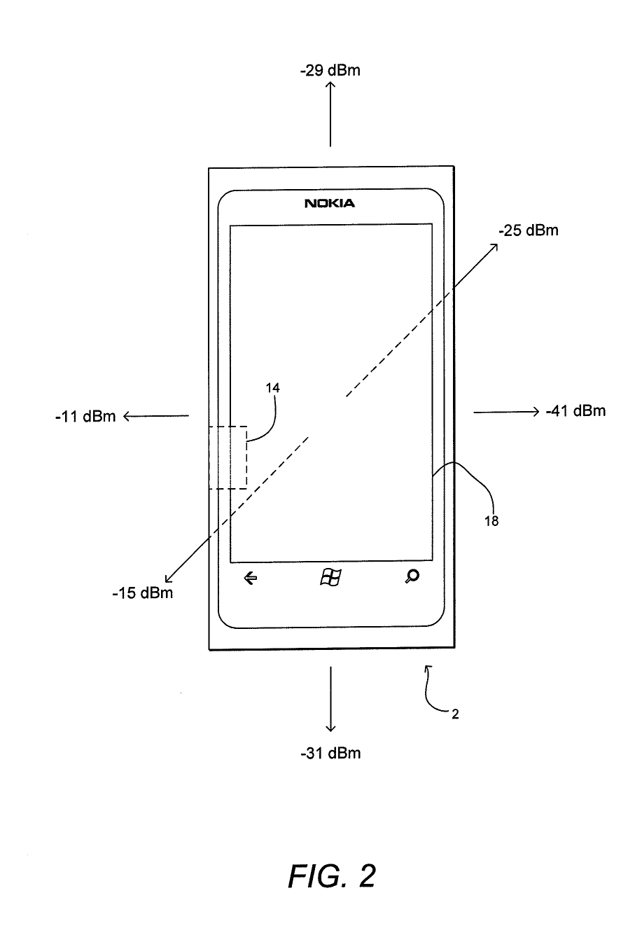

FIG. 2 is a front-on view of a portable wireless communication device 2 which comprises apparatus 1 in accordance with example embodiments, such as that shown in FIG. 1. The user interface 18 is visible from the exterior of the wireless communication device 2, and in this instance comprises a display 18-1 and a touch interface 18-2. The location of the antenna 14 is illustrated on the device 2 of FIG. 2. It will, however, be appreciated that the antenna 14 is often internal to the device 2 and so its location it not actually visible from the exterior of the device 2. The location of the antenna 14 in FIG. 2 is an example only. The location of short range, or local, communications antennas vary between different models of wireless communication device and may be selected based on many different factors. In this instance, the portable wireless communications device 2 is mobile telephone. Consequently, the device 2 includes a primary long range communication antenna (not shown) for communicating over a cellular network. Typically, this primary antenna will take priority over the shorter-range antenna 14 and so is located at a more suitable location in the device than is the shorter range antenna 14. Suitable locations for primary antennas tend to be, for example, locations over which a user's hand is unlikely to be positioned. As primary antennas generally take precedence, it is not uncommon for shorter range communication antennas to be positioned in less suitable locations, such as that shown in FIG. 2.

The strengths of radio frequency (RF) signals omitted by short, or local, range communication antennas, such as the antenna 14 of FIG. 1, vary at different directions around the antenna 14. The variations in signal strength may result from the antenna radiation pattern, the physical configuration of the device in which the antenna 14 is located and the position of the user's body when operating the device. FIG. 2 shows, in a very simplified way, an example of field strength measured at various points around the device. In general, as is clear from FIG. 2, higher field strengths are detected at points around the device that are closer to the antenna 14. In view of this fact, when attempting to initiate a wireless communication session, the location of the antenna 14 of the wireless communication device 2 relative to the other device participating in the session may be important. This may be particularly true in communication methods in which a high signal strength threshold must be surpassed before a wireless communication session is initiated. The provision of a threshold reduces the probability of unintended connections occurring between two devices.

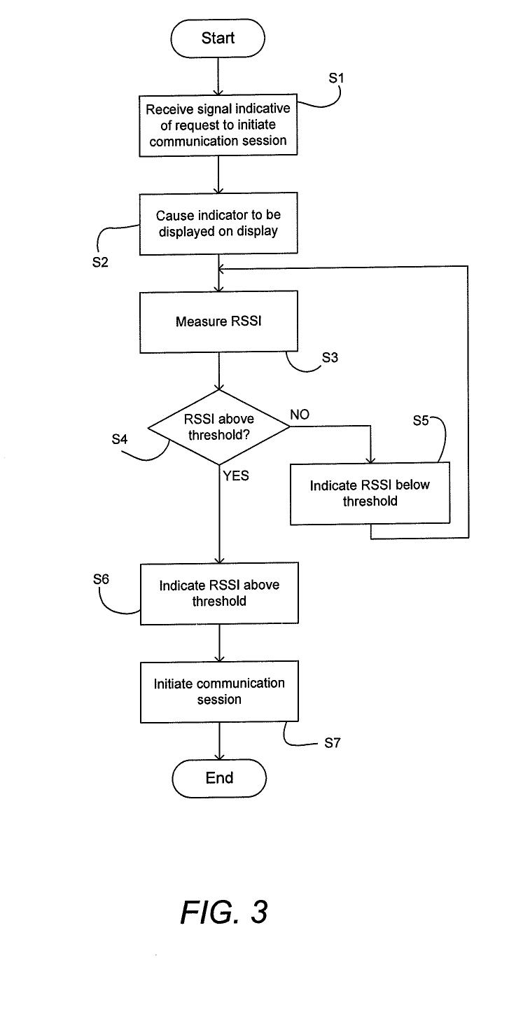

FIG. 3 is an example of a method which may be carried out by the controller 10 of FIG. 1. In step S1, the controller 10 receives a signal indicative of a request to initiate a wireless communication session with another wireless communication device. This signal may have originated from the user-input interface 18-2 of the device 2 and so may be indicative of a user providing an input requesting that a wireless communication session be initiated. Alternatively, the signal may have originated from the antenna 14 and the wireless communication module 16 and may be indicative of another wireless communication device requesting that the wireless communication session be initiated. In this case, the signal may be received by the controller 10 in response to a Bluetooth or other type of inquiry packet having been received at the antenna 14.

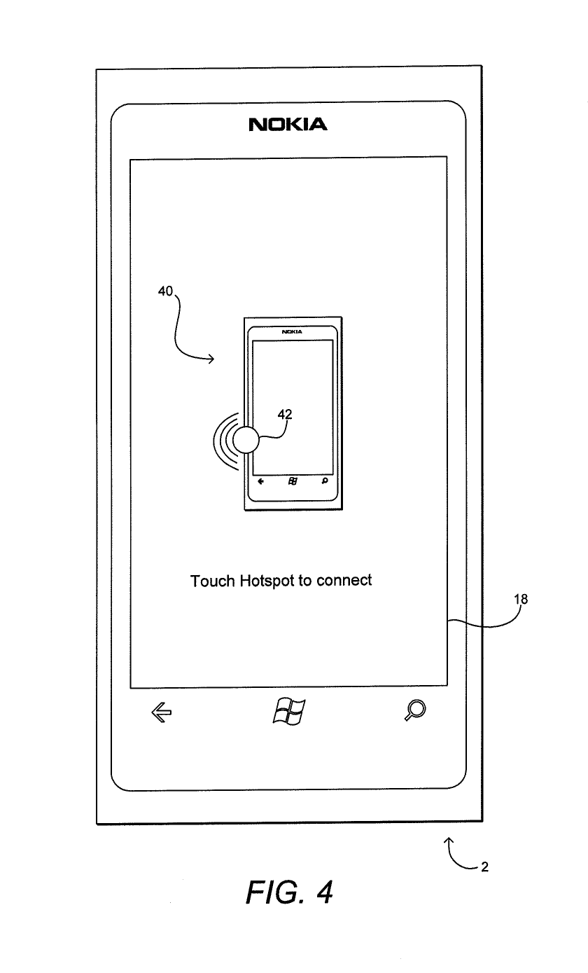

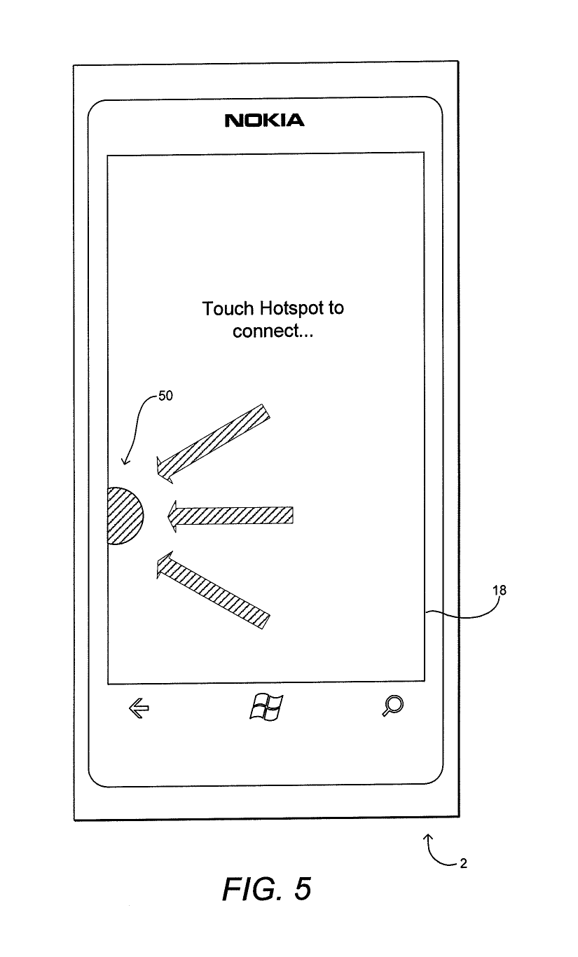

In step S2, the controller 10 responds to receipt of this signal by causing an indicator (such as the example indicators 40, 50 of FIGS. 4 and 5) to be displayed on the display 18-1. The indicator 40, 50 may be referred to as a graphical orientation indicator. The indicator 40, 50 is configured to indicate to the user an orientation of the device 2 with respect to a second device (not shown) with which the communication session is to be initiated. Orientation of the device 2 as indicated by the indicator 40, 50 facilitates the initiation of the wireless communication session. This is because, if the device 2 is orientated relative to the other device as indicated by the indicator 40, 50, the antenna 14 of the communication device 2 is nearer to the communication device with which the communication session is to be initiated. Consequently, the attenuation of the radio signals exchanged between the two devices may be reduced. The indicator 40, 50 is configured to indicate the orientation of the device 2 relative to a second device with which the communication session is to be initiated by indicating to the user a part of the device 2 which should be brought as close as possible to the second device. The indicator 40, 50 may indicate, for example, a location of the antenna 14, or a surface of the device 2 which is most proximate to the antenna 14. Alternatively, the indicator 40, 50 may indicate a region of an exterior surface of the device 2 from which the field emitted by the antenna 14 is at a maximum. The location from which the maximum field strength is emitted is also the location at which the device is most sensitive to incoming signals. In other examples, the indicator 40, 50 may indicate a region of the device from which emanates a field strength that is sufficiently large to allow a wireless communication session to be initiated.

FIGS. 4 and 5 show displayed on the display 18-1 of a wireless communication device 2 indicators 40, 50 in accordance with example embodiments.

In the example of FIG. 4, the indicator 40 comprises an image of the wireless communication device on which is indicated a location 42 on the device 2 which should be directed towards the second device with which the communication session is to be initiated. As can be seen from FIG. 4, the controller 10 may also cause guidance or instructions for facilitating the initiation of the wireless communication session to be provided to the user. In the example of FIG. 4, the guidance is in the form of text displayed on the display. However, it will be appreciated that the guidance may be provided as an audio stream output by the speaker, a vibration pattern output by a vibration module, an animation displayed on the display or in any other suitable way. In some examples, the controller 10 may be configured to detect, for example using proximity sensors (not shown), when a user's hand is located over the antenna 14 and may respond to detection of this condition by guiding or instructing the user to remove their hand.

FIG. 5 shows a different example of an indicator 50 that may be displayed by the device in accordance with example embodiments. In this example, the indicator 50 is displayed at a location of the display 18-1 that is most proximal to the location on the device 2 from which the maximum field due to the antenna 14 is emitted. The distance between the indicated location and the actual location of maximum field may depend to some extent on the size of the display screen 18-1. For example, where the location of the maximum field is at an edge of the device 2, it is possible to indicate this location more accurately when the display 18-1 extends all the way to the edge of the device 2, than if the display 18-1 covers a smaller region of the device 2. On some newer devices, in which the entire outer surface of the device comprises a display screen, the indicator 50 may be provided directly over the location of maximum field strength. Although not shown in FIGS. 4 and 5, the indicator 40, 50 may be animated.

In examples in which the indicator 50 is displayed as close as possible to the location of maximum field strength, such as that shown in FIG. 5, the location of the maximum field strength may be stored in memory 12 and may be referenced by the controller 10 following step S1 and prior to the indicator 50 being displayed in step S2.

Returning now to FIG. 3, in step S3 the controller 10 causes the signal strength received at the antenna 14 to be measured.

Next, in step S4, the controller determines if an indication of the received signal strength (RSSI) is above a threshold RSSI at which the communication session is initiated. In some examples, the RSSI threshold may be so high that the two devices must be in very close proximity, for example touching, before a communication session can be initiated. In some cases the threshold may only be surpassed when the devices 2 are in very close proximity and when the antennas 14 of the two devices are facing one another.

If, in step S4, it is determined that the RSSI is below the RSSI threshold the controller 10 proceeds to step S5, in which an indication of this is caused to be provided to the user. This indication may be provided in any suitable way, for example, via the display, the speaker and/or a vibration module. In some examples, this indication is provided by adapting the appearance of the indicator 40, 50 displayed in step S2. For example, the colour of all or part of the indicator 40, 50 may be adapted to indicate that the RSSI is below the threshold. In some examples, all or part of the indicator may be displayed in the colour red when the RSSI is below the threshold.

Subsequent to step S4, the controller returns to step S3 in which the RSSI is once again measured.

If, in step S4, it is determined that the RSSI is above the threshold, the controller 10 proceeds to step S6. In step S6, the controller 10 causes this fact to be indicated to the user. As described with reference to step S5, this may be achieved in any suitable way. One such way is to adapt the appearance of the indicator 40, 50, for example by changing the colour of all or a part of the indicator 40, 50 to green.

In some examples, the controller 10 may cause a value of the RSSI to be indicated. In some instances the RSSI threshold may also be indicated. For example, the value of the measured RSSI, and optionally also the threshold, may be indicated using numerals displayed on the display. Alternatively, the value of the RSSI relative to the threshold may be indicated. In some examples, the value of the measured RSSI may be indicated by adapting the size of all or part of the indicator 40, 50 based on the RSSI. For example, the size of the relevant part of the indicator may be proportional to the measured RSSI. In these examples, the threshold may also be indicated by displaying an outline indicating the size at which the relevant part of the indicator 40, 50 would be if the RSSI were equal to the threshold. In alternative examples, the value of the RSSI and/or the RSSI value relative to the threshold may be indicated in any suitable way using, for example animations or graphics on the display 18-1 and audio data provided by the speaker 20, a vibration module (not shown) or LEDs provided on the device (not shown).

Subsequent to step S6, the controller 10 proceeds to step S7 in which the wireless communication session is initiated. After this the method ends.

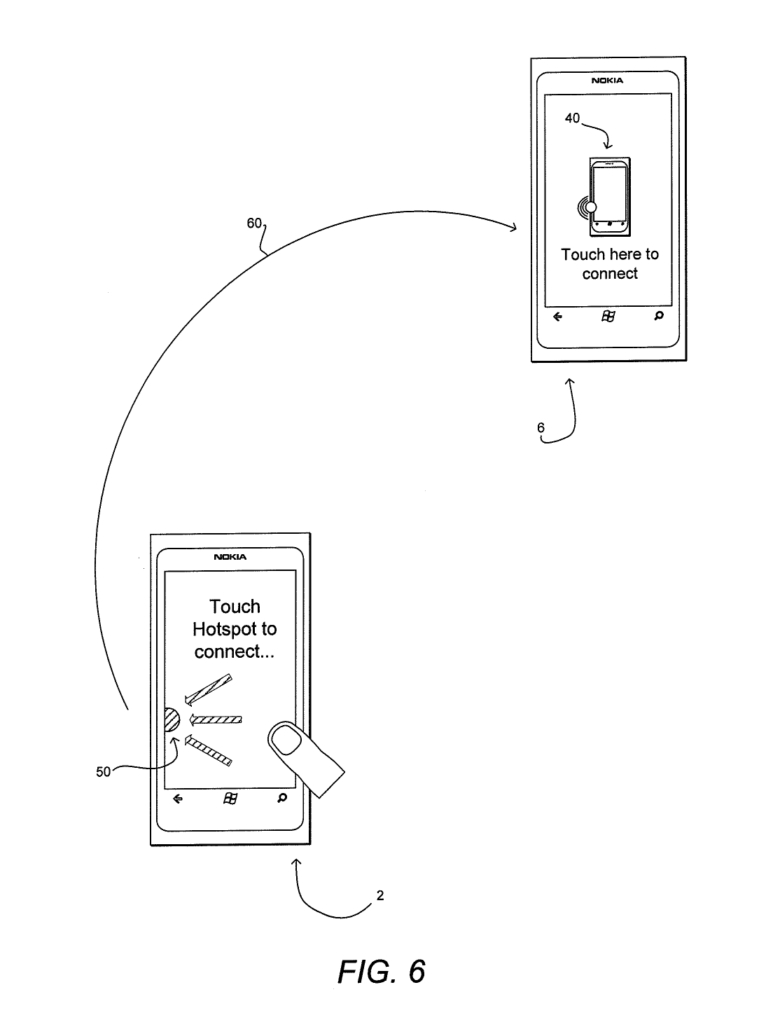

In some examples, the method of FIG. 3 may be carried out by both wireless communication devices simultaneously. In this case, for one of the devices 2, step S1 may comprise receiving a signal indicative of a user input requesting initiation of a communication session and, for the other device, step S1 may comprise receiving a signal indicative of an inquiry packet or the like having been received at the antenna 14 of the device 2. This can be seen in FIG. 6 in which a user input provided at the first communications device 2 causes an inquiry packet 60 to be sent to the second device 6. In addition, the user input also causes the first device 2 to display the indicator 50. In response to receiving the inquiry packet 60, the second device displays the indicator 40 indicating the location on the second device 6 that should be brought into close proximity with the first device 2.

It will of course be appreciated that the method illustrated in FIG. 3 is only an example. As such, various steps may be omitted and/or the order of the steps may be changed. For example, steps S3 and S4 may be carried out prior to step S2. In this way, when the indicator 40, 50 is initially displayed it is already adapted to indicate whether or not the RSSI is above the threshold. In some examples, step S6 may be omitted and the controller may instead proceed directly to initiating the communication session when it is determined that the RSSI is above the threshold. In other examples, the steps S6 and S7 may be caused to be performed simultaneously. In such examples, an indication that a session has been initiated may also act to inform the user that the RSSI is above the threshold.

As will be understood, the above example embodiments facilitate the initiation of wireless communication sessions between two devices. This is because the indicator 40, 50 indicates to the user the orientation at which the device 2 should be held relative to the other device. In addition, the indicator 40, 50 indicates to the user a region of their device 2 over which they should not place their hand when attempting to initiate a wireless communication session. Thus, attenuation of the field due to the antenna may be reduced. Also, when example embodiments described herein are used in short range communication systems which have a signal strength threshold that must be surpassed before a communication session can be initiated, the threshold may be set to a higher level. Consequently, the chance of pairing with an incorrect device may be reduced.

It should be realized that the foregoing embodiments should not be construed as limiting. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. An apparatus comprising:
at least one processor; and
at least one memory including computer program code, the at least one memory and the computer program code configured to, with the at least one processor, cause the apparatus:
to receive a signal indicative of a request to initiate a wireless communication session using an antenna of a first wireless communication device; and
responsive to the signal, to cause an indicator to be displayed on a display of the first wireless communication device, the indicator being configured to indicate to a user an orientation of the first wireless communication device with respect to a second communication device for facilitating the initiation of a wireless communication session between the first wireless communication device and the second wireless communication device using the antenna.

2. The apparatus of claim 1, the at least one memory and the computer program code configured to, with the at least one processor, cause the apparatus:
to measure a strength of a signal received at the antenna from the second wireless communication device; and
to cause an indication of the measured signal strength to be provided to the user of the first wireless communication device.

3. The apparatus of claim 1, the at least one memory and the computer program code configured to, with the at least one processor, cause the apparatus:
to determine if a measured strength of the received signal is above a predetermined threshold; and
when the measured strength of the received signal is above the predetermined threshold, to initiate a wireless communication session with the second wireless communication device.

4. The apparatus of claim 3, the at least one memory and the computer program code configured to, with the at least one processor, cause the apparatus:
to cause an indication of the initiation of the wireless communication session to be provided to the user of the first wireless communication device.

5. The apparatus of claim 1, wherein the indicator is configured to indicate the orientation by indicating a location on the first wireless communication device at which a strength of a field produced by the antenna is sufficiently large to allow a wireless communication session to be initiated with a second wireless communication device.

6. The apparatus of claim 5, wherein the indicator is configured to indicate to the user a location on the first wireless communication device at which the strength of the field produced by the antenna is at a maximum.

7. The apparatus of claim 1, wherein the request to initiate the wireless communication session comprises a user input received at a user interface of the first wireless communications device.

8. The apparatus of claim 1, wherein the request to initiate the wireless communication session comprises an inquiry packet received at the antenna of the first wireless communication device from the second wireless communication device.

9. The apparatus of claim 1, wherein the indicator is configured to indicate a location of the antenna of the first device.

10. A method comprising:
receiving a signal indicative of a request to initiate a wireless communication session using an antenna of a first wireless communication device, and
responding to the signal by causing an indicator to be displayed on a display of the first wireless communication device, the indicator being configured to indicate to a user an orientation of the first wireless communication device with respect to a second communication device for facilitating the initiation of a wireless communication session between the first wireless communication device and the second wireless communication device using the antenna.

11. The method of claim 10 further comprising:
measuring a strength of a signal received at the antenna from the second wireless communication device; and
causing an indication of the measured signal strength to be provided to the user of the first wireless communication device.

12. The method of claim 10, comprising:
determining if a measured strength of the received signal is above a predetermined threshold; and
when the measured strength of the received signal is above the predetermined threshold, initiating a wireless communication session with the second wireless communication device.

13. The method of claim 12, comprising causing an indication of the initiation of the wireless communication session to be provided to the user of the first wireless communication device.

14. The method of claim 10, wherein the indicator is configured to indicate the orientation by indicating a location on the first wireless communication device at which a strength of a field produced by the antenna is sufficiently large to allow a wireless communication session to be initiated with a second wireless communication device.

15. The method of claim 14, wherein the indicator is configured to indicate to the user a location on the first wireless communication device at which the strength of the field produced by the antenna is at a maximum.

16. The method of claim 10, wherein the request to initiate the wireless communication session comprises a user input received at a user interface of the first wireless communications device.

17. The method of claim 10, wherein the request to initiate the wireless communication session comprises an inquiry packet received at the antenna of the first wireless communication device from the second wireless communication device.

18. The method of claim 10 wherein the indicator is configured to indicate a location of the antenna of the first device.

19. A non-transitory computer readable memory medium having computer readable instructions stored thereon, the computer readable instructions, when executed by at least one processor, causing the at least one processor to:
to receive a signal indicative of a request to initiate a wireless communication session using an antenna of a first wireless communication device; and
responsive to the signal, to cause an indicator to be displayed on a display of the first wireless communication device, the indicator being configured to indicate to a user an orientation of the first wireless communication device with respect to a second communication device for facilitating the initiation of a wireless communication session between the first wireless communication device and the second wireless communication device using the antenna.

20. (canceled)
